(19) United States
(12) Patent Application Publication
(10) Pub. No.: US 2021/0248843 A1
(43) Pub. Date: Aug. 12, 2021

(54) VEHICLE DIAGNOSTIC SYSTEM

(71) Applicant: TOYOTA JIDOSHA KABUSHIKI KAISHA, Toyota-shi (JP)

(72) Inventor: Yoshitaka SUZUKI, Nagakute-shi (JP)

(73) Assignee: TOYOTA JIDOSHA KABUSHIKI KAISHA, Toyota-shi (JP)

(21) Appl. No.: 17/075,769

(22) Filed: Oct. 21, 2020

(30) Foreign Application Priority Data
Feb. 7, 2020 (JP) 2020-020170

(51) Int. Cl. G07C 5/08; B60W 40/08; B60W 50/02

(52) U.S. Cl. CPC G07C 5/0808; B60W 40/08; B60W 2040/0809; G07C 5/0816; B60W 50/0205

(57) ABSTRACT

Rank information indicating the rank of a vehicle damage, attributed to driving operation by an object driver among a plurality of drivers, in the vehicle damages attributed to driving operation by each of the drivers is generated. The generated rank information is provided to the object driver or a manager of a vehicle driven by the object driver. This makes it possible to know whether the object driver performs driving operation better for vehicle durability than other drivers.

### CROSS-REFERENCE TO RELATED APPLICATIONS

This application claims priority to Japanese Patent Application No. 2020-020170 filed on Feb. 7, 2020, incorporated herein by reference in its entirety.

### BACKGROUND

### Technical Field

The present disclosure relates to a vehicle diagnostic system for ranking the degree of deterioration in vehicle durability.

### Description of Related Art

A vehicle diagnostic system for ranking the degree of deterioration in vehicle durability is known well. One example of the vehicle diagnostic system is a vehicle evaluation system disclosed in Japanese Patent Application Publication No. 2012-174102 (JP 2012-174102 A). JP 2012-174102 A discloses generating ranking data on vehicles ranked based on data regarding a deterioration degree and a maintenance degree of components constituting each vehicle, and providing a user or the like with a relative rank of a specific vehicle among the vehicles based on the generated ranking data. JP 2012-174102 A also discloses generating ranking data for every vehicle type, every grade, every registration area, or every area.

### SUMMARY

Now, there are cases where a vehicle or a plurality of vehicles are used by a plurality of drivers. Even in such a case, the deterioration degree of durability can be ranked in units of vehicles by referring to JP 2012-174102 A. However, it is hard to recognize which driver, among a plurality of drivers, performs driving operation that causes deterioration in vehicle durability to what extent. In other words, it is hard to recognize whether or not an object driver, among a plurality of drivers, performs driving operation good for vehicle durability. For this reason, it cannot encourage the object driver to perform driving operation that restrains deterioration in vehicle durability.

The present disclosure has been made with these circumstances as a background, and it is an object of the present disclosure to provide a vehicle diagnostic system capable of encouraging an object driver to perform driving operation that restrains deterioration in vehicle durability even when a vehicle to be used or the driver to drive the vehicle is not fixed.

A first aspect of the present disclosure relates to (a) a vehicle diagnostic system for ranking a degree of deterioration in vehicle durability. The vehicle diagnostic system includes: (b) a driver authentication unit; (c) a durability deterioration degree calculation unit; (d) a rank information generation unit; and (e) a rank information providing unit. The driver authentication unit is configured to authenticate each of a plurality of drivers. The durability deterioration degree calculation unit is configured to calculate, based on travel information indicating travel states during vehicle driving by the respective drivers, degrees of deterioration in vehicle durability attributed to driving operation by the respective drivers. The rank information generation unit is configured to generate rank information indicating a rank of the degree of deterioration in vehicle durability, attributed to the driving operation by an object driver among the drivers, in the calculated degrees of deterioration in vehicle durability. The rank information providing unit is configured to provide the rank information to the object driver or a manager of a vehicle driven by the object driver.

In a second aspect of the present disclosure relating to the vehicle diagnostic system according to the first aspect, the drivers may be drivers who drive vehicles managed by an identical company.

In a third aspect of the present disclosure relating to the vehicle diagnostic system according to the first aspect, the drivers may be drivers who drive vehicles used for an identical usage.

In a fourth aspect of the present disclosure relating to the vehicle diagnostic system according to the first aspect, the drivers may be drivers who drive vehicles used in an identical area.

In a fifth aspect of the present disclosure relating to the vehicle diagnostic system according to the first aspect, the drivers may be drivers divided into an identical characteristic class.

In a sixth aspect of the present disclosure relating to the vehicle diagnostic system according to the first aspect, the drivers may be drivers who drive vehicles having an identical vehicle characteristic.

In a seventh aspect of the present disclosure relating to the vehicle diagnostic system according to any one of the first to sixth aspects, the travel information may be load information indicating at least one type of load applied to a vehicle power transmission device that transmits motive power of a power source to driving wheels, and the degree of deterioration in vehicle durability may be a degree of deterioration in durability of the vehicle power transmission device.

In an eighth aspect of the present disclosure relating to the vehicle diagnostic system according to any one of the first to sixth aspects, the durability deterioration degree calculation unit may be configured to calculate the degree of deterioration in vehicle durability by applying a prescribed weight to a plurality of items included in the travel information.

In a ninth aspect of the present disclosure relating to the vehicle diagnostic system according to the eighth aspect, the items may be different types of load applied to a vehicle power transmission device that transmits motive power of a power source to driving wheels, and the durability deterioration degree calculation unit may be configured to calculate, as the degree of deterioration in vehicle durability, a degree of deterioration in durability of the vehicle power transmission device by applying the prescribed weight to the different types of load.

In a tenth aspect of the present disclosure relating to the vehicle diagnostic system according to the ninth aspect, one piece of information used for setting the prescribed weight may be component information indicating variation of components constituting the vehicle power transmission device.

In an eleventh aspect of the present disclosure relating to the vehicle diagnostic system according to any one of the first to sixth aspects, the travel information may be load information indicating at least one type of load applied to a vehicle power transmission device that transmits motive power of a power source to driving wheels, and the load may be total load per one travel, load per travel distance, or load per traveling time.

In a twelfth aspect of the present disclosure relating to the vehicle diagnostic system according to any one of the first to eleventh aspects, the rank information providing unit may further be configured to provide progress information to the object driver or the manager, the progress information indicating vehicle driving by the object driver or a vehicle position or time of driving operation by the object driver when the degree of deterioration in vehicle durability progresses.

According to the first aspect of the present disclosure, rank information is generated. The rank information indicates the rank of the degree of deterioration in vehicle durability, attributed to driving operation performed by an object driver among a plurality of authenticated drivers, in the degrees of deterioration in vehicle durability attributed to driving operation performed by the respective drivers, the degrees of deterioration being calculated based on the travel information indicating the travel states at the time of vehicle driving by the respective drivers. The generated rank information is provided to the object driver or the manager of the vehicle driven by the object driver. This makes it possible to know whether the object driver performs driving operation better for vehicle durability than other drivers. Therefore, even when the vehicle to be used or the driver to drive is not fixed, it is possible to encourage the object driver to perform driving operation that restrains deterioration in vehicle durability.

According to the second aspect, the drivers are drivers who drive the vehicles managed by an identical agent. This makes it possible to know whether the object driver performs driving operation better for vehicle durability than other drivers who drive the vehicles managed by the identical agent.

According to the third aspect, the drivers are drivers who drive the vehicles used for an identical usage. This makes it possible to know whether the object driver performs driving operation better for vehicle durability than other drivers who drive the vehicles used for the identical usage.

According to the fourth aspect, the drivers are drivers who drive the vehicles used in an identical area. This makes it possible to know whether the object driver performs driving operation better for vehicle durability than other drivers who drive the vehicles used in the identical area.

According to the fifth aspect, the drivers are drivers divided into an identical characteristic class. This makes it possible to know whether the object driver performs driving operation better for vehicle durability than other drivers who are divided into the identical characteristic class.

According to the sixth aspect, the drivers are drivers who drive the vehicles having an identical vehicle characteristic. This makes it possible to know whether the object driver performs driving operation better for vehicle durability than other drivers who drive the vehicles having the identical vehicle characteristic.

According to the seventh aspect, the travel information is load information indicating at least one type of load applied to a vehicle power transmission device, and the degree of deterioration in vehicle durability is a degree of deterioration in durability of the vehicle power transmission device. This makes it possible to know whether the object driver performs driving operation better for durability of the vehicle power transmission device than other drivers.

According to the eighth aspect, the degree of deterioration in vehicle durability is calculated by applying the prescribed weight to a plurality of items included in the travel information. Accordingly, the degree of deterioration in vehicle durability attributed to driving operation is appropriately calculated.

According to the ninth aspect, the items are different types of load applied to the vehicle power transmission device, and the degree of deterioration in durability of the vehicle power transmission device is calculated by applying the prescribed weight to the different types of load. Accordingly, the degree of deterioration in durability of the vehicle power transmission device attributed to driving operation is appropriately calculated. This makes it possible to know whether the object driver performs driving operation better for durability of the vehicle power transmission device than other drivers.

According to the tenth aspect, one piece of information used for setting the prescribed weight is component information indicating variation of components constituting the vehicle power transmission device. Accordingly, the degree of deterioration in durability of the vehicle power transmission device attributed to driving operation is more appropriately calculated.

According to the eleventh aspect, the travel information is load information indicating at least one type of load applied to a vehicle power transmission device, and the load is total load per one travel, load per travel distance, or load per traveling time. Accordingly, the degree of deterioration in vehicle durability attributed to driving operation is appropriately calculated.

According to the twelfth aspect, the progress information is provided to the object driver or the manager of the vehicle driven by the object driver, the progress information indicating vehicle driving by the object driver or a vehicle position or time of driving operation performed by the object driver when the degree of deterioration in vehicle durability progresses. This makes it possible to appropriately encourage the object driver to perform driving operation that restrains deterioration in vehicle durability.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an explanatory view of the schematic configuration of a vehicle to which the present disclosure is applied, and is also an explanatory view of a vehicle diagnostic system;

FIG. 2 is a flowchart illustrating a principal part of control operation of an electronic control device, the flowchart illustrating control operation in order to implement a vehicle diagnostic system capable of encouraging an object driver to perform driving operation that restrains deterioration in vehicle durability even when a vehicle to be used or the driver to drive the vehicle is not fixed; and

FIG. 3 is a flowchart illustrating the principal part of the control operation of the electronic control device, the flowchart illustrating control operation in order to implement the vehicle diagnostic system capable of encouraging an object driver to perform driving operation that restrains deterioration in vehicle durability even when a vehicle to be used or the driver to drive the vehicle is not fixed in an embodiment different from that of FIG. 2.

### DETAILED DESCRIPTION OF EMBODIMENTS

In embodiments of the present disclosure, the power source is an engine, such as a gasoline engine and a diesel engine, which generates motive power by combustion of fuel. The vehicle may also include, as the power source, an electric motor or the like in addition to or in place of the engine.

The vehicle power transmission device includes, for example, a transmission. The transmission includes, for example, a publicly-known planetary gear automatic transmission, a publicly-known synchromesh parallel two-shaft automatic transmission, a publicly known dual clutch transmission (DCT) that is a synchromesh parallel two-shaft automatic transmission of a type having two clutches, a publicly-known belt-type stepless transmission, a publicly-known electric stepless transmission, a publicly-known automatic transmission having a plurality of power transmission lines provided in parallel, the power transmission lines including a first power transmission line and a second power transmission line, the first power transmission line having a gear transmission mechanism interposed between an input rotating member and an output rotating member, the second power transmission line having a stepless transmission interposed therebetween, and a publicly-known synchromesh parallel two-shaft manual transmission. Alternatively, in a vehicle having only the electric motor that is mechanically coupled with the driving wheels to enable motive power transmission, the vehicle power transmission device may be configured without the transmission, for example.

Hereinbelow, the embodiments of the present disclosure will be described in detail with reference to the accompanying drawings.

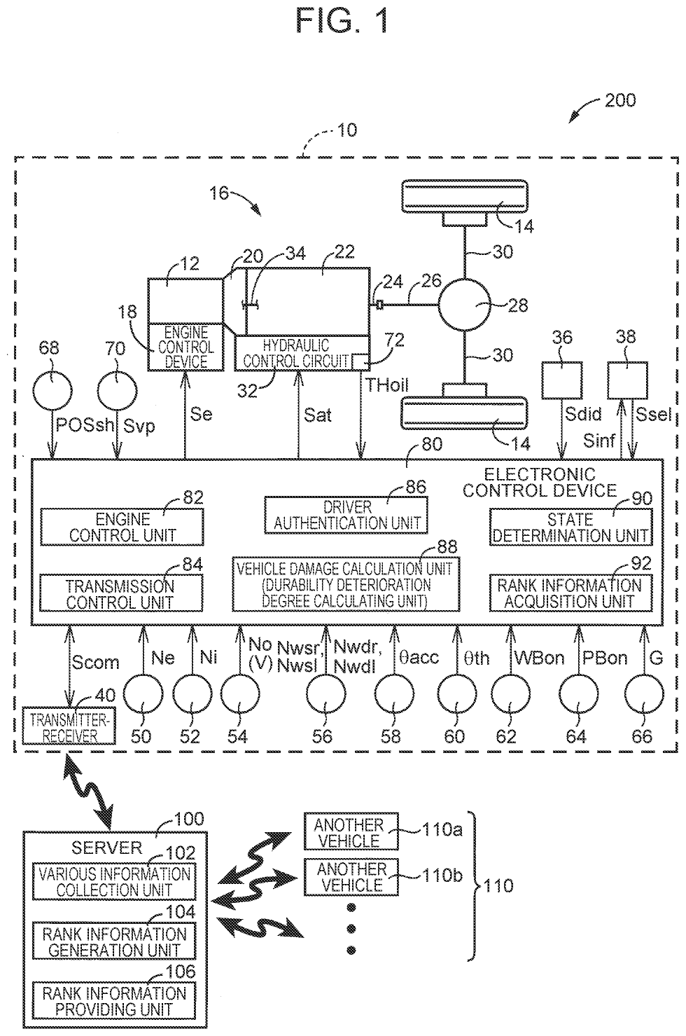

FIG. 1 is an explanatory view of the schematic configuration of a vehicle 10 to which the present disclosure is applied, and is also an explanatory view of a principal part of control functions and a control system for various control in the vehicle 10. In FIG. 1, the vehicle 10 includes an engine 12, driving wheels 14, and a vehicle power transmission device 16 that transmits motive power of the engine 12 to the driving wheels 14. Hereinafter, the vehicle power transmission device 16 is called a power transmission device 16.

The engine 12 is a power source for traveling of the vehicle 10, that is, for example, a publicly-known internal combustion engine. In the engine 12, engine torque Te that is output torque of the engine 12 is controlled when a later-described electronic control device 80 controls an engine control device 18 including a throttle actuator, a fuel injection device, and an ignition device, included in the vehicle 10.

The power transmission device 16 includes a torque converter 20 coupled with the engine 12, an automatic transmission 22 coupled with the torque converter 20, a propeller shaft 26 coupled with an AT output shaft 24 serving as an output rotating member of the automatic transmission 22, a differential gear 28 coupled with the propeller shaft 26, and a pair of drive shafts 30 coupled with the differential gear 28. In the power transmission device 16, the motive power output from the engine 12 is transmitted to the driving wheels 14 through the component members such as the torque converter 20, the automatic transmission 22, the propeller shaft 26, the differential gear 28, and the drive shafts 30 in sequence. Unless otherwise specified, the motive power is equivalent to torque and power.

The automatic transmission 22 is a transmission constituting part of a power transmission line between the engine 12 and the driving wheels 14. For example, the automatic transmission 22 is a publicly-known planetary gear automatic transmission including one or more sets of planetary gear drives and a plurality of engagement devices. In the automatic transmission 22, the operating states of the engagement device, such as an engaged state and a disengaged state, are switched by hydraulic pressure of hydraulic oil OIL supplied from a hydraulic control circuit 32 that is included in the vehicle 10 and controlled by the later-described electronic control device 80. Thus, in the automatic transmission 22, a plurality of gear stages different in gear ratio γ(=AT input rotation speed Ni/AT output rotation speed No) are selectively formed. The AT input rotation speed Ni is a rotation speed of an AT input shaft 34 that is an input rotating member of the automatic transmission 22, i.e., an input rotation speed of the automatic transmission 22. The AT input shaft 34 is coupled with a turbine impeller that is an output rotating member of the torque converter 20. The AT output rotation speed No is a rotation speed of the AT output shaft 24, i.e., an output rotation speed of the automatic transmission 22.

The vehicle 10 also includes a driver authentication device 36, an information notification device 38, and a transmitter-receiver 40.

The driver authentication device 36 is a publicly-known biometric authentication device that performs personal identification according to a bodily feature, such as a fingerprint, a face, a vein pattern, an iris, or a voiceprint. The bodily feature may be acquired with a mobile terminal carried by a driver, for example. Alternatively, the driver authentication device 36 may be a publicly-known authentication device that performs personal identification with the mobile terminal possessed by the driver, or an identification card (ID card) carried by the driver, for example. Alternatively, the driver authentication device 36 may be, for example, a switch or a panel that allows the driver to select or input personal information.

The information notification device 38 is a display device, such as a monitor and a display, used to display various information IvA to a driver or the like. The various information IvA corresponds to, for example, failure information Ifl indicating failure or function deterioration of some components related to traveling of the vehicle 10, or later-described rank information Irk. The information notification device 38 also serves as an input device for selectively displaying the information desired by the driver out of the various information IvA, for example.

The transmitter-receiver 40 is a device that communicates with a server 100 through a prescribed network outside the vehicle 10. The server 100 is an external device that is independent of the vehicle 10 and provided separately from the vehicle 10. The server 100 receives, processes, analyzes, accumulates, or provides various information IvB. The later-described electronic control device 80 exchanges the various information IvB with the server 100 through the transmitter-receiver 40. The server 100 exchanges the various information IvB with vehicles 110a, 110b (referred to as other vehicles 110 unless otherwise specified) other than the vehicle 10, as in the case of information exchange with the vehicle 10. In other words, the server 100 exchanges the various information IvB with a plurality of vehicles including the vehicle 10 and the other vehicles 110. The other vehicles 110 basically have the same function as the vehicle 10. The transmitter-receiver 40 may also have a function to directly perform vehicle-to-vehicle communication with the other vehicles 110 present in the vicinity of the vehicle 10 without through the server 100.

Examples of the various information IvB include later-described vehicle damage information Idm, position information Ivp, time information Itm, rank information Irk, driver information Idi, and vehicle information Ivi. Examples of the position information Ivp include vehicle position information indicating a current position of the vehicle 10 on the ground or the map, based on global positioning system (GPS) signals (orbital signals) or the like transmitted by GPS satellites. The time information Itm includes, for example, information on current time and date based on a clock included in the vehicle 10 or on GPS signals and the like. The driver information Idi includes, for example, personal identification information relating to a driver. The driver information Idi may include, for example, personal information such as age and sex of the driver, and an agent to which the driver belong. The vehicle information Ivi includes, for example, at least one piece of information out of an agent that manages the vehicle 10, a usage for using the vehicle 10, an area where the vehicle 10 is used, a total travel distance of the vehicle 10, a displacement of the vehicle 10, and a vehicle type of the vehicle 10. Examples of the usage for using the vehicle 10 include usage as a private car, usage as a limousine taxi, usage as a taxi, car-sharing, or ride-sharing. Examples of the area where the vehicle 10 is used include continents, countries, states, or prefectures. Examples of the area where the vehicle 10 is used may include areas with Asia, the EU, the U.S., or the like being set as one unit, and areas with an urban area, a suburban area, a mountainous area, or the like being set as one unit.

The vehicle 10 further includes the electronic control device 80 as a controller including a control device of the vehicle 10. The electronic control device 80 is configured by including a so-called microcomputer including a CPU, a RAM, a ROM, and an input-output interface, for example. The CPU executes a variety of control of the vehicle 10 by performing signal processing in accordance with programs prestored in the ROM, while using a temporary storage function of the RAM. The electronic control device 80 is configured by including computers for engine control, transmission control, and the like as necessary.

The electronic control device 80 receives information such as various signals based on detection values and acquisition information from component members such as various sensors and various devices included in the vehicle 10. Examples of the various sensors and various devices include an engine speed sensor 50, an input rotation speed sensor 52, an output rotation speed sensor 54, a wheel speed sensor 56, an accelerator operation amount sensor 58, a throttle valve opening degree sensor 60, a wheel brake switch 62, a parking brake switch 64, a G sensor 66, a shift position sensor 68, a position sensor 70 including a GPS antenna, an oil temperature sensor 72, the driver authentication device 36, the information notification device 38, and the transmitter-receiver 40. Examples of the various signals include an engine speed Ne that is the speed of the engine 12, the AT input rotation speed Ni, the AT output rotation speed No corresponding to vehicle speed V, wheel speeds Nwdr, Nwdl that are rotation speeds Nwd of the right and left driving wheels 14, wheel speeds Nwsr, Nwsl that are wheel speeds Nws of right and left driven wheels not shown, an accelerator operation amount θacc that is the amount of accelerator operation by the driver, the accelerator operation amount θacc indicating the magnitude of the accelerating operation made by the driver, a throttle valve opening degree θth that is the opening degree of an electronic throttle valve, a wheel brake ON signal WBon that is a signal indicating the state where a brake pedal for operating the wheel brake is operated by the driver, a parking brake ON signal PBon that is a signal indicating the state where a parking brake is operated, a longitudinal acceleration G of the vehicle 10, an operation position POSsh of a shift lever included in the vehicle 10, a position signal Svp including the position information Ivp, a hydraulic oil temperature THoil that is the temperature of the hydraulic oil OIL in the hydraulic control circuit 32, a driver authentication signal Sdid including the driver information Idi, an information display selection signal Ssel that is a signal indicating the type of various information IvA selected by the driver or the like in order to display the information on the information notification device 38, and a communication signal Scom including the various information IvB. The electronic control device 80 also outputs information such as various command signals to the devices included in the vehicle 10. Examples of the devices include the engine control device 18, the hydraulic control circuit 32, the information notification device 38, and the transmitter-receiver 40. Examples of the various command signals include an engine control command signal Se for controlling the engine 12, a transmission control command signal Sat for controlling the automatic transmission 22, an information display control command signal Sinf for displaying the various information IvA on the information notification device 38, and the communication signal Scom.

Examples of the operation position POSsh include P, R, N, D operation positions. The P operation position is a parking operation position for selecting a parking position (=P position) of the automatic transmission 22 where the automatic transmission 22 is set to a neutral state and rotation of the AT output shaft 24 is mechanically prevented. The neutral state of the automatic transmission 22 is the state where, for example, the automatic transmission 22 is disabled from transmitting motive power. The state where rotation of the AT output shaft 24 is prevented is the state of parking lock (=P lock) where the AT output shaft 24 is unrotatably fixed. The AT output shaft 24 is unrotatably fixed by a parking lock pole meshing with a parking lock gear provided so as to integrally rotate with the AT output shaft 24. The R operation position is a reverse travel operation position for selecting a reverse travel position (=R position) of the automatic transmission 22 where reverse travel of the vehicle 10 is enabled. The N operation position is a neutral operation position for selecting a neutral position (=N position) of the automatic transmission 22 where the automatic transmission 22 is set to the neutral state. The D operation position is a forward travel operation position for selecting a forward drive position (=D position) of the automatic transmission 22 where forward travel of the vehicle 10 is enabled, for example.

In order to implement various control in the vehicle 10, the electronic control device 80 includes engine control means that is an engine control unit 82, and transmission control means that is a transmission control unit 84.

The engine control unit 82 calculates a driving force requirement that is required by a driver to the vehicle 10 by, for example, applying an accelerator operation amount θacc and a vehicle speed V to a driving force map. The driving force map indicates a relationship obtained experimentally or in design and stored in advance, i.e., a predetermined relationship. The driving force requirement is, for example, a demanded driving force Fddem that is demanded by the driver to the vehicle 10. Here, the demanded driving force Fddem may be replaced with demanded driving torque or the like. The vehicle speed V may also be replaced with the AT output rotation speed No or the like. The engine control unit 82 calculates target engine torque Tetgt of the engine 12 for implementing the demanded driving force Fddem, based on transmission loss, accessory load, a reduction ratio of the differential gear 28, a gear ratio γ of the automatic transmission 22, and the like. The engine control unit 82 outputs to the engine control device 18 an engine control command signal Se for controlling the engine 12 so as to be able to obtain the target engine torque Tetgt.

The transmission control unit 84 determines shifting of the automatic transmission 22 using, for example, a shift map that is a preset relationship, and outputs to the hydraulic control circuit 32 a transmission control command signal Sat for executing shift control of the automatic transmission 22 as necessary. For example, the shift map is a prescribed relationship having a shift line, used for determining shifting in the automatic transmission 22, on two-dimensional coordinates having the vehicle speed V and the demanded driving force Fddem as variables.

Here, the electronic control device 80 is a component member constituting a vehicle diagnostic system 200 for ranking the degree of deterioration in vehicle durability. FIG. 1 is also an explanatory view of the vehicle diagnostic system 200 including the electronic control device 80 and the like. In FIG. 1, the vehicle diagnostic system 200 includes the electronic control device 80 and the server 100. Therefore, the server 100 is also a component member constituting the vehicle diagnostic system 200. The electronic control devices mounted on other vehicles 110 function as a device constituting the vehicle diagnostic system 200 like the electronic control device 80.

For example, the degree of deterioration in vehicle durability is expressed as a value indicating to what extent the durability of the vehicle 10 deteriorates, i.e., expresses how much deterioration of the vehicle 10 progresses in a numerical form. As the value of the degree of deterioration in vehicle durability is larger, it indicates that the durability of the vehicle 10 is deteriorated more, i.e., the deterioration of the vehicle 10 progresses more. In the present embodiment, the degree of deterioration in vehicle durability is referred to as a vehicle damage DM. In the present embodiment, the degree of deterioration in durability of the power transmission device 16 is illustrated as the vehicle damage DM.

Now, there are cases where the vehicle 10 or a plurality of vehicles including the vehicle 10 and other vehicles 110 are used by a plurality of drivers Drp. In such a case, when vehicle damages DM are ranked in units of the vehicle 10 or other vehicles 110, it is hard to recognize to what extent the driving operation by a specific driver i.e., an object driver Dro, among the drivers Drp, deteriorates the vehicle durability, i.e., the vehicle damage DM. For this reason, it is difficult to encourage the object driver Dro to perform driving operation that restrains deterioration in vehicle durability.

Hence, in order to implement the vehicle diagnostic system 200 capable of encouraging the object driver Dro to perform driving operation that restrains deterioration in vehicle durability even when a vehicle to be used or the driver to drive the vehicle is not fixed, the electronic control device 80 further includes driver authentication means that is a driver authentication unit 86, vehicle damage calculation means as a durability deterioration degree calculation means, that is, a vehicle damage calculation unit 88 as a durability deterioration degree calculation unit, state determination means that is a state determination unit 90, and rank information acquisition means that is a rank information acquisition unit 92. In order to implement the vehicle diagnostic system 200 as described above, the server 100 also includes various information collection means that is a various information collection unit 102, rank information generation means that is a rank information generation unit 104, and rank information providing means that is a rank information providing unit 106.

The driver authentication unit 86 authenticates each of the drivers Drp using the driver authentication device 36.

The vehicle damage calculation unit 88 acquires travel information Ist indicating the travel state at the time of vehicle driving by each of the drivers Drp. In other words, the vehicle damage calculation unit 88 acquires the travel information Ist associated with a driver authenticated by the driver authentication unit 86. For example, the travel information Ist includes a plurality of items that influence the deterioration in vehicle durability attributed to the driving operation of the driver. For example, the travel information Ist is load information Ild indicating the items, i.e., different types of load applied to the power transmission device 16.

Examples of the different types of load applied to the power transmission device 16 include load of bearings included in the power transmission device 16, load of gears included in the power transmission device 16, the number of times the engine 12 is started up, the number of times stall operation in which both an accelerator pedal and the brake pedal are depressed is performed, the number of times or total time that the operation position POSsh is set to the P operation position during traveling, the number of times or total time that any one of the driving wheels 14 is slipped, the number of times that differential is generated in which a differential rotation speed of the differential gear 28 reaches a threshold value or more, and the number of times that the automatic transmission 22 is put in the parking position at the time of parking on a steep slope road that is steeper than a threshold value. The bearings are components constituting the power transmission device 16 to support rotating members, such as the AT input shaft 34 and the AT output shaft 24, for example. The gears are components constituting the power transmission device 16, such as the differential gear 28 and gears that are meshed for motive power transmission.

For example, the load of the bearings and the load of the gears tend to be increased, as the engine torque Te corresponding to the driving force requirement to the vehicle 10 by the driver is larger. At the time of the startup of the engine 12, load may be applied to the bearings or the gears. The hydraulic oil OIL is also used as lubrication oil in the power transmission device 16. When the hydraulic oil temperature THoil is higher than a regular use range, the load of the bearings and the load of the gears tend to be increased due to exhaustion of lubricant. Alternatively, when the hydraulic oil temperature THoil is lower than the regular use range, smooth movement of the bearings and the gears are disturbed, which may cause the load of the bearings and the load of the gears to become larger. The load of the bearings and the load of the gears tend to be increased, as the number of times that the hydraulic oil temperature THoil becomes higher than the regular use range is larger, or the total time that the hydraulic oil temperature THoil becomes higher than the regular use range is longer, for example. The load of the bearings and the load of the gears tend to be increased, as the number of times that the hydraulic oil temperature THoil becomes lower than the regular use range is larger, or the total time that the hydraulic oil temperature THoil becomes lower than the regular use range is longer, for example.

When the operation position POSsh is set to the P operation position during traveling, the parking lock pole is unlatched from the parking lock gear. Hence, load is applied to the parking lock pole or the parking lock gear. As the vehicle speed V is higher, a larger load is applied. Hence, the load of the parking lock pole and the load of the parking lock gear may be increased, as a maximum vehicle speed when the operation position POSsh is set to the P operation position during traveling is higher. Alternatively, the load of the parking lock pole and the load of the parking lock gear may be increased, as maximum continuous time while the operation position POSsh is set to the P operation position during traveling is longer. Alternatively, in the case where there is a resonance region when the parking lock pole is unlatched from the parking lock gear, a large load is applied within a specific vehicle speed section serving as the resonance region. The number of times or the total time that the operation position POSsh is set to the P operation position during traveling may be the number of times or the total time that the operation position POSsh is set to the P operation position during traveling within the specific vehicle speed section. In relation to the operation position POSsh being set to the P operation position during traveling, the number of times that the operation position POSsh is set to the R operation position during forward traveling, or the number of times that the operation position POSsh is set to the D operation position during reverse traveling may be added as the load applied to the power transmission device 16.

When both the driving wheels 14 slip, the rotating members in the power transmission device 16 are in a high rotational state, and thereby load will be applied to the bearings or the gears. Alternatively, when one of the driving wheels 14 slips, a differential rotation speed is generated in the differential gear 28, and therefore load is applied to the differential gear 28.

When the automatic transmission 22 set to the parking position at the time of parking on the steep slope road that is steeper than a threshold value, load is applied to the parking lock pole or the parking lock gear. Such load is smaller in the state where the parking brake is operated than in the state where the parking brake is not operated. The number of times that the automatic transmission 22 is set to the parking position at the time of parking on the steep slope road that is steeper than a threshold value may be distinguished between the number of times in the state where the parking brake is operated and the number of times in the state where the parking brake is not operated.

The vehicle damage calculation unit 88 calculates the vehicle damages DM attributed to the driving operation by the respective drivers Drp based on the travel information Ist. In other words, the vehicle damage calculation unit 88 calculates the vehicle damage DM associated with each of the drivers authenticated by the driver authentication unit 86. The vehicle damage information Idm includes information on the vehicle damage DM associated with a driver. The vehicle damage DM associated with the driver corresponds to a vehicle damage DM attributed to the driving operation by the driver.

The vehicle damage calculation unit 88 converts different types of load, applied to the power transmission device 16 included in the travel information Ist, to numerical form based on prescribed rules, and calculates a total value as the vehicle damage DM. For example, when former vehicle damage information Idm associated with a current driver is stored in the server 100, the vehicle damage calculation unit 88 acquires the former vehicle damage information Idm from the server 100. Then, the vehicle damage calculation unit 88 calculates the latest vehicle damage DM by adding the vehicle damage DM calculated this time to the former vehicle damage DM in the former vehicle damage information Idm.

Although the total load is used as the different types of load, the total load per one travel, the load per travel distance, or the load per traveling time may be used. In this case, the vehicle damage calculation unit 88 can omit to apply the vehicle damage DM calculated this time to the former vehicle damage DM, and can also omit to acquire the former vehicle damage information Idm from the server 100. The vehicle damage DM calculated this time is calculated as the latest vehicle damage DM. The one travel refers to one driving, i.e., one trip of the vehicle from ignition turning on to ignition turning off.

In the different types of load, it is considered that the load per one time applied to the bearings and the like differs. For this reason, when converting the load into numerical form, the vehicle damage calculation unit 88 may apply a prescribed weight Wld to each of the different types of load. A larger prescribed weight Wld is preset, as the load per one time is larger, or the influence exerted to the deterioration in vehicle durability is larger. Thus, the vehicle damage calculation unit 88 may calculate the vehicle damage DM by applying the prescribed weight Wld to the different types of load to the power transmission device 16 included in the travel information Ist.

In relation to applying the prescribed weight Wld to the different types of load, the vehicle damage calculation unit 88 may calculate the vehicle damage DM by converting a few types or one type of load having a larger prescribed weight Wld applied thereto, among the different types of load, into numerical. In short, the travel information Ist may be the load information Ild indicating at least one type of load applied to the power transmission device 16.

A progress degree of the vehicle damage DM may change depending on the variation of components constituting the power transmission device 16. The prescribed weight Wld may be set in accordance with the variation of the components constituting the power transmission device 16. Specifically, one piece of information used for setting the prescribed weight Wld is component information Ipt indicating variation of the components constituting the power transmission device 16. For example, the component information Ipt is data on life time of the components constituting the power transmission device 16, or on traceability of the components constituting the power transmission device 16 in manufacturing.

The state determination unit 90 determines whether or not the vehicle damage DM calculated by the vehicle damage calculation unit 88 is updated.

When the state determination unit 90 determines that the vehicle damage DM is updated, the rank information acquisition unit 92 transmits various information IvB, such as the vehicle damage information Idm, the position information Ivp, the time information Itm, the driver information Idi, and the vehicle information Ivi, to the server 100 through the transmitter-receiver 40.

The various information collection unit 102 collects the various information IvB, such as the vehicle damage information Idm, the position information Ivp, the time information Itm, the driver information Idi, and the vehicle information Ivi, received from the vehicle 10. The various information collection unit 102 then divides the collected information for each of the drivers Drp, and stores the divided information. The various information collection unit 102 also collects similar various information IvB from other vehicles 110, divides the collected information for each of the drivers Drp, and stores the divided information.

The state determination unit 90 determines, based on an information display selecting signal Ssel from the information notification device 38, whether or not there is an instruction to display on the information notification device 38 the rank of the vehicle damage DM attributed to the driving operation by an object driver Dro.

When the state determination unit 90 determines that there is an instruction to display the rank of the vehicle damage DM, the rank information acquisition unit 92 transmits a rank request Reqrk requesting transmission of the rank of the vehicle damage DM attributed to the driving operation by the object driver Dro to the server 100 through the transmitter-receiver 40.

When the rank request Reqrk is received, the rank information generation unit 104 calculates the rank of the vehicle damage DM, attributed to the driving operation by the object driver Dro among the drivers Drp, in the vehicle damages DM each calculated by the vehicle damage calculation unit 88. The rank information generation unit 104 generates rank information Irk indicating the calculated rank of the vehicle damage DM.

When the drivers Drp are assumed to be all the drivers Dr having their vehicle damages DM calculated, the rank of the object driver Dro is in all the drivers Dr. When the range of a population of the drivers Drp is narrowed down, the rank in a specific range can be recognized.

For example, in the case of recognizing the rank in an identical agent, the drivers Drp may be the drivers who drive the vehicles managed by the identical agent. Alternatively, in the case of recognizing the rank in an identical usage, the drivers Drp may be the drivers who drive the vehicles used for the identical usage. Alternatively, in the case of recognizing the rank in an identical area, the drivers Drp may be the drivers who drive the vehicles used in the identical area. Alternatively, in the case of recognizing the rank in an identical driver characteristic, the drivers Drp may be the drivers divided into an identical characteristic class. Examples of the driver characteristic include generation, age, or sex. The drivers Drp are divided based on, for example, the vehicle information Ivi or the driver information Idi.

The rank information providing unit 106 transmits the rank information Irk generated by the rank information generation unit 104 to the vehicle 10, and provides the information to the object driver Dro or a manager GM of the vehicle driven by the object driver Dro. As a result, the rank of the object driver Dro can be reflected upon a reward given to the object driver Dro, for example.

When the details of the driving operation by the object driver Dro, used as the basis of calculation of the rank of the vehicle damage DM, can be recognized, it is possible to appropriately encourage the object driver Dro to perform driving operation that restrains deterioration in vehicle durability. The rank information providing unit 106 may further transmit to the vehicle 10 the progress information Ipr indicating vehicle driving by the object driver Dro, the position of the vehicle, or the time of driving operation performed by the object driver Dro when the vehicle damage DM progresses, and may provide the information to the object driver Dro or the manager GM. The vehicle driving by the object driver Dro corresponds to one trip. The progress information Ipr is generated based on, for example, the position information Ivp, the time information Itm, or the like.

The state determination unit 90 determines whether or not the rank information Irk, including the rank of the vehicle damage DM of the object driver Dro, is received from the server 100.

When the state determination unit 90 determines that the rank information Irk is received, the rank information acquisition unit 92 outputs an information display control command signal Sinf for displaying the rank of the vehicle damage DM of the object driver Dro to the information notification device 38.

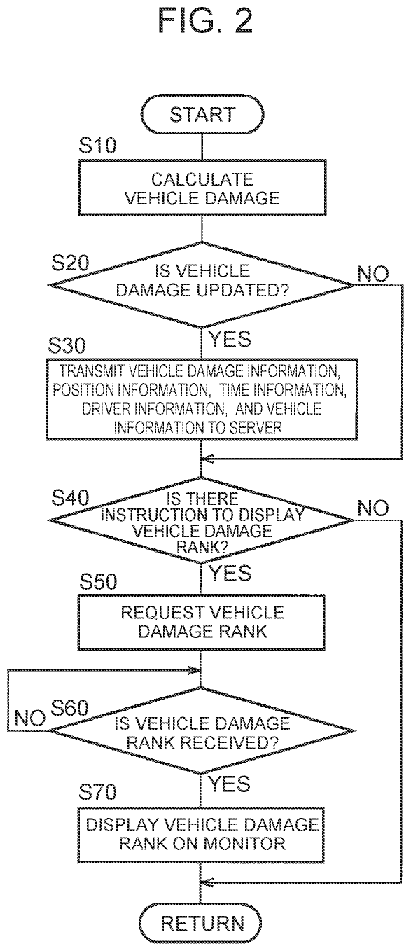

FIG. 2 is a flowchart illustrating a principal part of the control operation of the electronic control device 80. FIG. 2 is also the flowchart illustrating control operation in order to implement the vehicle diagnostic system 200 capable of encouraging the object driver Dro to perform driving operation that restrains deterioration in vehicle durability even when a vehicle to be used or the driver to drive the vehicle is not fixed. The control operation is repeatedly executed when, for example, the ignition of the vehicle 10 is turned on.

In FIG. 2, first in step (hereinafter, “step” is omitted) S10 corresponding to the function of the vehicle damage calculation unit 88, the vehicle damage DM is calculated based on the travel information Ist. Next, in S20 corresponding to the function of the state determination unit 90, it is determined whether the vehicle damage DM is updated. When a positive determination is made in S20, then in S30 corresponding to the function of the rank information acquisition unit 92, the various information IvB, such as the vehicle damage information Idm, the position information Ivp, the time information Itm, the driver information Idi, and the vehicle information Ivi, is transmitted to the server 100. In the server 100, the various information collection unit 102 collects the various information IvB received from the vehicle 10 or the other vehicles 110. The collected various information IvB is divided for each of the drivers Drp and is stored. When a negative determination is made in S20, or subsequent to S30, it is determined in S40, corresponding to the function of the state determination unit 90, whether or not there is an instruction to display on the information notification device 38 the rank of the vehicle damage DM attributed to the driving operation by the object driver Dro. When a negative determination is made in S40, the present routine is ended. When a positive determination is made in S40, then in S50 corresponding to the function of the rank information acquisition unit 92, a rank request Reqrk requesting transmission of the rank of the vehicle damage DM attributed to the driving operation by the object driver Dro is transmitted to the server 100. In the server 100, the rank information generation unit 104 calculates the rank of the vehicle damage DM attributed to the driving operation by the object driver Dro. The rank information providing unit 106 transmits the rank information Irk indicating the calculated rank of the vehicle damage DM to the vehicle 10. In S60 corresponding to the function of the state determination unit 90 that is subsequent to S50, it is determined whether or not the rank information Irk including the rank of the vehicle damage DM of the object driver Dro is received from the server 100. When a negative determination is made in S60, the process of S60 is repeatedly executed. When a positive determination is made in S60, then in S70 corresponding to the function of the rank information acquisition unit 92, the rank of the vehicle damage DM of the object driver Dro is displayed on the monitor of the information notification device 38.

As described above, in the present embodiment, rank information Irk is generated. The rank information Irk indicates the rank of the vehicle damage DM, attributed to the driving operation performed by the object driver Dro among a plurality of authenticated drivers Drp, in the vehicle damages DM attributed to driving operation performed by the respective drivers Drp, the vehicle damages DM being calculated based on the travel information Ist indicating the travel states at the time of vehicle driving by the respective drivers Drp. The generated rank information Irk is provided to the object driver Dro or the manager GM of the vehicle driven by the object driver Dro. This makes it possible to know whether the object driver Dro performs driving operation better for vehicle durability than other drivers. Therefore, even when a vehicle to be used or the driver to drive is not fixed, it is possible to encourage the object driver Dro to perform driving operation that restrains deterioration in vehicle durability.

According to the present embodiment, the drivers Drp are drivers who drive the vehicles managed by an identical agent. This makes it possible to know whether the object driver Dro performs driving operation better for vehicle durability than other drivers who drive the vehicles managed by the identical agent.

According to the present embodiment, the drivers Drp are drivers who drive the vehicles used for an identical usage. This makes it possible to know whether the object driver Dro performs driving operation better for vehicle durability than other drivers who drive the vehicles used for the identical usage.

According to the present embodiment, the drivers Drp are drivers who drive the vehicles used in an identical area. This makes it possible to know whether the object driver Dro performs driving operation better for vehicle durability than other drivers who drive the vehicles used in the identical area.

According to the present embodiment, the drivers Drp are drivers divided into an identical characteristic class. This makes it possible to know whether the object driver Dro performs driving operation better for vehicle durability than other drivers who are divided into the identical characteristic class.

According to the present embodiment, the travel information Ist is the load information Ild indicating at least one type of load applied to the power transmission device 16, and the vehicle damage DM is the degree of deterioration in durability of the power transmission device 16. This makes it possible to know whether the object driver Dro performs driving operation better for durability of the power transmission device 16 than other drivers.

Moreover, according to the present embodiment, the vehicle damage DM is calculated by applying a prescribed weight Wld to a plurality of items included in the travel information Ist. Hence, the vehicle damage DM attributed to driving operation is appropriately calculated.

According to the present embodiment, the items are different types of load applied to the power transmission device 16, and the degree of deterioration in durability of the power transmission device 16 is calculated by applying the prescribed weight Wld to the different types of load. Accordingly, the degree of deterioration in durability of the power transmission device 16 attributed to driving operation is appropriately calculated. This makes it possible to know whether the object driver Dro performs driving operation better for durability of the power transmission device 16 than other drivers.

According to the present embodiment, one piece of information used for setting the prescribed weight Wld is the component information Ipt indicating variation of the components constituting the power transmission device 16. Accordingly, the degree of deterioration in durability of the power transmission device 16 attributed to driving operation is more appropriately calculated.

According to the present embodiment, the travel information Ist is the load information Ild indicating at least one type of load applied to the power transmission device 16. The load is total load per one travel, load per travel distance, or load per traveling time. Accordingly, the vehicle damage DM attributed to driving operation is appropriately calculated.

According to the present embodiment, the progress information Ipr indicating vehicle driving by the object driver Dro, the position of the vehicle, or the time of driving operation performed by the object driver Dro when the vehicle damage DM progresses is provided to the object driver Dro or the manager GM. This makes it possible to appropriately encourage the object driver Dro to perform driving operation that restrains deterioration in vehicle durability.

Description is now given of another embodiment of the present disclosure. In the following description, component members common in the embodiments are designated by identical reference signs to omit the description thereof.

The vehicle damages DM may differ in progress degree depending on the degree of deterioration of the vehicle 10. The rank of the vehicle damage DM of the object driver Dro within a range divided according to the degree of deterioration of the vehicle 10 may also be recognized. In the present embodiment, difference in total travel distance of the vehicle 10 is illustrated as the degree of deterioration of the vehicle 10.

When determining that there is an instruction to display the rank of the vehicle damage DM, the state determination unit 90 determines whether or not the total travel distance of the vehicle 10 is equal to or more than a prescribed distance DT. For example, the prescribed distance DT is a threshold value set in advance as the total travel distance of the vehicle 10 that may easily cause a difference in the progress degree of the vehicle damage DM. For example, the threshold is 50,000 [km].

When the state determination unit 90 determines that there is an instruction to display the rank of the vehicle damage DM, and determines that the total travel distance of the vehicle 10 is equal to or more than the prescribed distance DT, the rank information acquisition unit 92 transmits a rank request ReqrkUP requesting transmission of the rank of the vehicle damage DM attributed to the driving operation by the object driver Dro, within the range where the vehicle having a total travel distance of equal to or more than the prescribed distance DT, to the server 100 through the transmitter-receiver 40. Meanwhile, when the state determination unit 90 determines that there is an instruction to display the rank of the vehicle damage DM, and determines that the total travel distance of the vehicle 10 is less than the prescribed distance DT, the rank information acquisition unit 92 transmits a rank request ReqrkDN requesting transmission of the rank of the vehicle damage DM attributed to the driving operation by the object driver Dro, within the range where the vehicle having a total travel distance of less than the prescribed distance DT, to the server 100 through the transmitter-receiver 40.

When the rank request ReqrkUP is received, the rank information generation unit 104 calculates the rank of the vehicle damage DM, attributed to the driving operation by the object driver Dro among the drivers Drp who have driven the vehicles that have a total travel distance equal to or more than the prescribed distance DT, in the vehicle damages DM each calculated by the vehicle damage calculation unit 88. The rank information generation unit 104 then generates rank information Irk indicating the calculated rank of the vehicle damage DM. When the rank request ReqrkDN is received, the rank information generation unit 104 calculates the rank of the vehicle damage DM, attributed to the driving operation by the object driver Dro among the drivers Drp who have driven the vehicles which have a total travel distance of less than the prescribed distance DT, in the vehicle damages DM each calculated by the vehicle damage calculation unit 88. The rank information generation unit 104 then generates rank information Irk indicating the calculated rank of the vehicle damage DM.

The vehicle damages DM may also differ in progress degree depending on a difference in displacement of the vehicle 10, or a difference in vehicle type of the vehicle 10. The vehicle damage DM may be divided based on the displacement of the vehicle 10 or the vehicle type of the vehicle 10 as in the case of dividing the vehicle damage DM based on the total travel distance of the vehicle 10. Thus, the drivers Drp may be drivers who drive the vehicles of an identical vehicle characteristic. Examples of the vehicle characteristic include the total travel distance of the vehicle 10, the displacement of the vehicle 10, or the vehicle type of the vehicle 10.

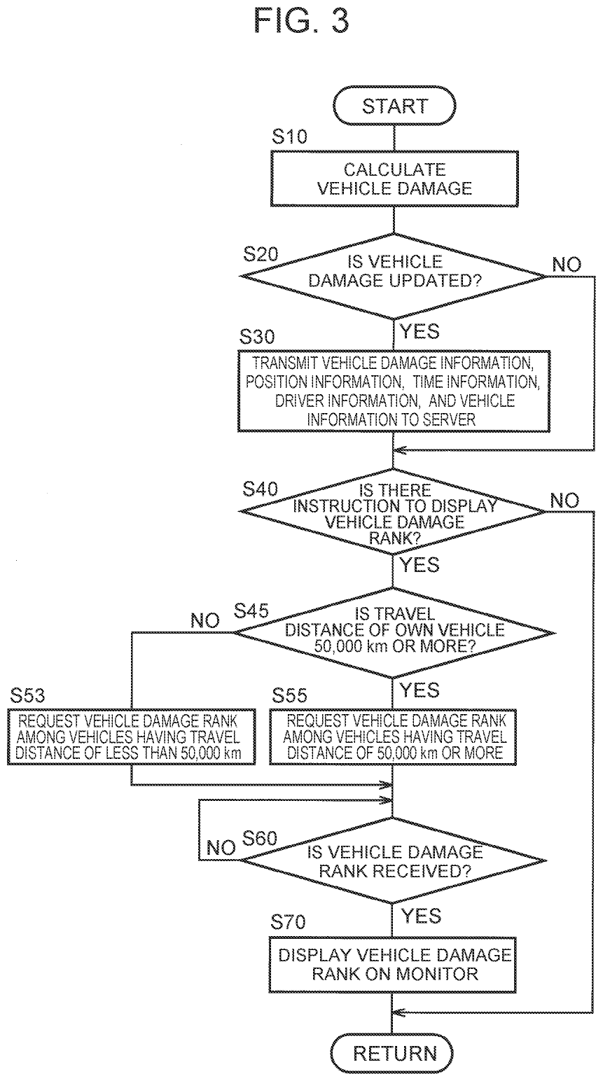

FIG. 3 is a flowchart illustrating a principal part of the control operation of the electronic control device 80. FIG. 3 is also the flowchart illustrating control operation in order to implement the vehicle diagnostic system 200 capable of encouraging the object driver Dro to perform driving operation that restrains deterioration in vehicle durability even when a vehicle to be used or the driver to drive the vehicle is not fixed. The control operation is repeatedly executed when, for example, the ignition of the vehicle 10 is turned on. FIG. 3 shows another embodiment different from the first embodiment in FIG. 2. Hereinbelow, description will be given of a portion of FIG. 3 different from FIG. 2.

In FIG. 3, when a positive determination is made in S40, then in S45 corresponding to the function of the state determination unit 90, it is determined whether or not the total travel distance of the vehicle 10 is, for example, 50,000 [km] or more. When a negative determination is made in S45, then in S53 corresponding to the function of the rank information acquisition unit 92, a rank request ReqrkDN requesting transmission of the rank of the vehicle damage DM attributed to the driving operation by the object driver Dro, within the range where the vehicle having a total travel distance of less than 50,000 [km], is transmitted to the server 100. On the contrary, when a positive determination is made in S45, then in S55 corresponding to the function of the rank information acquisition unit 92, a rank request ReqrkUP requesting transmission of the rank of the vehicle damage DM attributed to the driving operation by the object driver Dro, within the range where the vehicle having a total travel distance of 50,000 [km] or more, is transmitted to the server 100. In the server 100, the rank information generation unit 104 calculates the rank of the vehicle damage DM attributed to the driving operation by the object driver Dro in the range divided in accordance with the total travel distance. The rank information providing unit 106 transmits the rank information Irk indicating the calculated rank of the vehicle damage DM to the vehicle 10. In S60 corresponding to the function of the state determination unit 90 that is subsequent to S53 or S55, it is determined whether or not the rank information Irk indicating the rank of the vehicle damage DM of the object driver Dro is received from the server 100.

As described in the foregoing, in the present embodiment, the same effect as the aforementioned first embodiment is also obtained. In addition, since the drivers Drp are drivers who drive the vehicles having an identical vehicle characteristic, it is possible to know whether the object driver Dro performs driving operation better for vehicle durability than other drivers who drive the vehicles having the identical vehicle characteristic.

Although the embodiments of the present disclosure have been described in detail based on the drawings, the present disclosure is also applied to other aspects.

For example, in the aforementioned embodiments, the electronic control device 80 have the function of the vehicle damage calculation unit 88. However, an applicable embodiment of the present disclosure is not limited to the aspect. For example, the server 100 may include some or all of the functions of the vehicle damage calculation unit 88.

In the aforementioned embodiments, the degree of deterioration in durability of the power transmission device 16 is illustrated as the vehicle damage DM. However, an applicable embodiment of the present disclosure is not limited to the aspect. For example, the vehicle damage DM may be the degree of deterioration in durability of the entire vehicle 10, or the degree of deterioration in durability of the engine 12. In such a case, the load included in the travel information Ist is the load which influences deterioration in vehicle durability of the entire vehicle 10 or the engine 12. When such load is included in the travel information Ist as a plurality of items, the vehicle damage DM is calculated by applying a prescribed weight to the items.

Moreover, when the vehicle 10 is an electric motor including an electric motor, in addition to or in place of the engine 12, as a power source, the vehicle damage DM may be the degree of deterioration in durability of the electric motor. In such a case, the load included in the travel information Ist is the number of times or the total time that the rotation speed of the electric motor becomes equal to or more than a threshold value, or the number of times or the total time that the temperature of the electric motor becomes equal to or more than a threshold value, for example.

In the aforementioned embodiments, the means for transmitting the rank request Reqrk to the server 100 may include, in addition to transmitting from the vehicle 10, transmitting from a mobile terminal or a personal computer of an object driver Dro, a manager GM, or the like, and transmitting in association with an e-mail address registered in advance. The means for providing the rank information Irk to the object driver Dro or the manager GM may include, in addition to transmitting to the vehicle 10, transmitting to the mobile terminal or the personal computer of the object driver Dro, the manager GM, or the like, transmitting to an e-mail address registered in advance, and transmitting to a prescribed cloud server. Therefore, the rank of the vehicle damage DM of the object driver Dro does not necessarily need to be displayed on the monitor of the vehicle 10, or the like.

In the aforementioned embodiments, the rank of the vehicle damage DM attributed to the driving operation by the object driver Dro in the rank information Irk may be the rank other than the rank obtained by ranking the calculated individual vehicle damages DM themselves. Instead, the rank may be obtained by ranking based on which category or group the calculated vehicle damages DM are included, the category or group being divided according to vehicle damage ranges different in magnitude of the vehicle damage DM.

In the aforementioned embodiments, the present disclosure is applicable to any vehicle including a control device like the electronic control device 80.

The embodiments disclosed are merely examples, and the present disclosure may be carried out in the aspects to which various arrangements and modifications are applied based on the knowledge of those skilled in the art.

What is claimed is:

1. A vehicle diagnostic system for ranking a degree of deterioration in vehicle durability, comprising:
a driver authentication unit configured to authenticate each of a plurality of drivers;
a durability deterioration degree calculation unit configured to calculate, based on travel information indicating travel states during vehicle driving by the respective drivers, degrees of deterioration in vehicle durability attributed to driving operation by the respective drivers;
a rank information generation unit configured to generate rank information indicating a rank of the degree of deterioration in vehicle durability, attributed to the driving operation by an object driver among the drivers, in the calculated deterioration degrees in vehicle durability; and
a rank information providing unit configured to provide the rank information to the object driver or a manager of a vehicle driven by the object driver.

2. The vehicle diagnostic system according to claim 1, wherein the drivers are drivers who drive vehicles managed by an identical company.

3. The vehicle diagnostic system according to claim 1, wherein the drivers are drivers who drive vehicles used for an identical usage.

4. The vehicle diagnostic system according to claim 1, wherein the drivers are drivers who drive vehicles used in an identical area.

5. The vehicle diagnostic system according to claim 1, wherein the drivers are drivers divided into an identical characteristic class.

6. The vehicle diagnostic system according to claim 1, wherein the drivers are drivers who drive vehicles having an identical vehicle characteristic.

7. The vehicle diagnostic system according to claim 1, wherein:
the travel information is load information indicating at least one type of load applied to a vehicle power transmission device that transmits motive power of a power source to driving wheels; and
the degree of deterioration in vehicle durability is a degree of deterioration in durability of the vehicle power transmission device.

8. The vehicle diagnostic system according to claim 1, wherein the durability deterioration degree calculation unit is configured to calculate the degree of deterioration in vehicle durability by applying a prescribed weight to a plurality of items included in the travel information.

9. The vehicle diagnostic system according to claim 8, wherein:
the items are different types of load applied to a vehicle power transmission device that transmits motive power of a power source to driving wheels; and
the durability deterioration degree calculation unit calculates, as the degree of deterioration in vehicle durability, a degree of deterioration in durability of the vehicle power transmission device by applying the prescribed weight to the different types of load.

10. The vehicle diagnostic system according to claim 9, wherein one piece of information used for setting the prescribed weight is component information indicating variation of components constituting the vehicle power transmission device.

11. The vehicle diagnostic system according to claim 1, wherein:
the travel information is load information indicating at least one type of load applied to a vehicle power transmission device that transmits motive power of a power source to driving wheels; and
the load is total load per one travel, load per travel distance, or load per traveling time.

12. The vehicle diagnostic system according to claim 1, wherein the rank information providing unit is further configured to provide progress information to the object driver or the manager, the progress information indicating vehicle driving by the object driver or a vehicle position or time of driving operation by the object driver when the degree of deterioration in vehicle durability progresses.
